(19) United States
(12) Patent Application Publication
(10) Pub. No.: US 2016/0070368 A1
(43) Pub. Date: Mar. 10, 2016

(54) METHOD FOR CONTROLLING USER INTERFACE AND ELECTRONIC DEVICE SUPPORTING THE SAME

(71) Applicant: Samsung Electronics Co., Ltd., Suwon-si (KR)

(72) Inventors: Jihun Hong, Seoul (KR); Sunhee Kim, Seongnam-si (KR); Kwanghyun Kim, Incheon (KR); Yonghoon Jin, Seongnam-si (KR)

(21) Appl. No.: 14/846,136

(22) Filed: Sep. 4, 2015

(30) Foreign Application Priority Data
Sep. 5, 2014 (KR) 10-2014-0119189

(51) Int. Cl. G06F 3/0354; G06F 3/0484; G06F 3/16; G06F 3/0485

(52) U.S. Cl. CPC G06F 3/03543; G06F 3/0485; G06F 3/04847; G06F 3/165

(57) ABSTRACT

An electronic device includes a display module. The electronic device also includes an input interface configured to be functionally connected to the electronic, to transmit an input detection signal to the electronic device by detecting an input of additional input unit formed at a side, and to transmit to the electronic device at least one of a movement signal generated by detecting a movement while an input of the additional input unit is maintained and a scroll signal generated by detecting an input of a scroll unit installed at a side. The electronic device further includes a processor configured to receive an input detection signal from the input interface, to receive at least one of the movement signal and the scroll signal while the input of the additional input unit is maintained, and to control a user interface based on the received signal.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2014-0119189, filed on Sep. 5, 2014, which is hereby incorporated by reference for all purposes as if fully set forth herein.

### TECHNICAL FIELD

The present invention relates to a method for controlling a user interface and an electronic device supporting the same and, more particularly, to a method for controlling a user interface based on a received input and an electronic device supporting the same.

### BACKGROUND

Currently, a keyboards and a mouse are generally used as an input means for a computer. Most of available programs perform various input functions by using the mouse. The programs enabling an input by using a mouse generally performs a selection operation by clicking a left button of the mouse and an output operation of a popup menu by clicking a right button of the mouse. Further, by installing a scroll wheel between the right and left buttons of the mouse, a function of vertically moving programs displayed in a screen can be performed.

### SUMMARY

An electronic device according to a display of a user interface pre-stored in the electronic device only when an input interface connected to the electronic device reaches a specific location (such as an edge area of a screen) of the electronic device. This generates user inconveniences in displaying a user interface because the input interface must be moved a predetermined location to perform a desired function. Further, electronic device perform a corresponding function only when an input of selecting an input interface, such as a shortcut icon assigned to a predetermined function, is directly detected.

It is a primary object to provide a method for controlling a user interface and an electronic device supporting the same.

In a first embodiment, an electronic device is provided. The electronic device includes a display module. The electronic device also includes an input interface configured to be functionally connected to the electronic. The input interface is also configured to transmit an input detection signal to the electronic device by detecting an input of additional input unit formed at a side. The input interface is further configured to transmit to the electronic device at least one of a movement signal generated by detecting a movement while an input of the additional input unit is maintained and a scroll signal generated by detecting an input of a scroll unit installed at a side. The electronic device further includes a processor configured to receive an input detection signal from the input interface. The processor is also configured to receive at least one of the movement signal and the scroll signal while the input of the additional input unit is maintained. The processor is further configured to control a user interface based on the received signal.

In a second embodiment, an input interface is provided. The input interface includes a memory configured to store user interface control information corresponding to a movement signal generated by moving the input device while an input of an additional input unit installed at a side of the input interface is detected. The memory is also configured to store user interface control information corresponding to a scroll signal generated by detecting an input of a scroll unit while an input of the additional input unit is detected. The input interface also includes a communication interface. The communication interface is configured to transmit the stored user interface control information to an electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an example configuration of electronic device according to this disclosure;

FIG. 2 is a block diagram illustrating an example configuration of input interface according to this disclosure;

FIGS. 3A and 3B are schematic drawings illustrating an example configuration of input interface according to this disclosure;

FIG. 4 is a schematic drawing illustrating an example method of performing a function corresponding to an input of input interface in an electronic device according to this disclosure;

FIG. 5 is a schematic drawing illustrating an example method of performing a function corresponding to an input of input interface in an electronic device according to this disclosure;

FIG. 6 is a schematic drawing illustrating an example method of performing a function corresponding to an input of input interface in an electronic device according to this disclosure; and

FIG. 7 is a flowchart illustrating an example method of performing a function corresponding to an input of input interface in an electronic device according to this disclosure.

### DETAILED DESCRIPTION

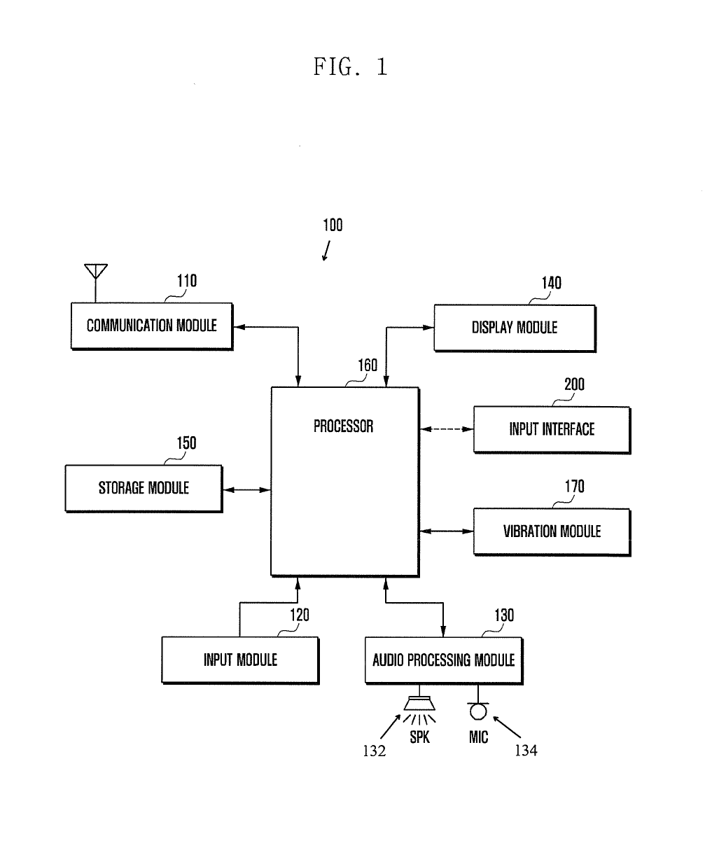

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, exemplary embodiments of the present disclosure are described in detail with reference to the accompanying drawings. While the present disclosure may be embodied in many different forms, specific embodiments of the present disclosure are shown in drawings and are described herein in detail, with the understanding that the present disclosure is to be considered as an exemplification of the principles of the invention and is not intended to limit the invention to the specific embodiments illustrated. The same reference numbers are used throughout the drawings to refer to the same or like parts.

An expression “comprising” or “may comprise” used in the present disclosure indicates presence of a corresponding function, operation, or element and does not limit additional at least one function, operation, or element. Further, in the present disclosure, a term “comprise” or “have” indicates presence of a characteristic, numeral, step, operation, element, component, or combination thereof described in a specification and does not exclude presence or addition of at least one other characteristic, numeral, step, operation, element, component, or combination thereof. In the present disclosure, an expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” to the other element or “electrically coupled” to the other element through a third element. However, when it is described that an element is “directly coupled” to another element, no element may exist between the element and the other element. Terms used in the present disclosure are not to limit the present disclosure but to illustrate exemplary embodiments. When using in a description of the present disclosure and the appended claims, a singular form includes a plurality of forms unless it is explicitly differently represented.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

In this disclosure, an electronic device can be a device that involves a communication function. For example, an electronic device can be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (such as a Head-Mounted Device (HMD)) such as electronic glasses, electronic clothes, an electronic bracelet, an electronic necklace, an electronic appcessory, a smart watch, or the like.

According to some embodiments, an electronic device can be a smart home appliance that involves a communication function. For example, an electronic device may be a TV, a DVD (Digital Video Disk) player, audio equipment, a refrigerator, an air conditioner, a vacuum cleaner, an oven, a microwave, a washing machine, an air cleaner, a set-top box, a TV box (such as SAMSUNG HOMESYNC™, APPLE TV™, GOOGLETV™, or the like), a game console, an electronic dictionary, an electronic key, a camcorder, an electronic picture frame, or the like.

According to some embodiments, an electronic device may be a medical device (such as a Magnetic Resonance Angiography (MRA), a Magnetic Resonance Imaging (MRI), a Computed Tomography (CT), an ultrasonography, or the like), a navigation device, a Global Positioning System (GPS) receiver, an Event Data Recorder (EDR), an Flight Data Recorder (FDR), a car infotainment device, electronic equipment for a ship (such as a marine navigation system, a gyrocompass, or the like), avionics, security equipment, an industrial or home robot, or the like.

According to some embodiments, an electronic device may be furniture or part of a building or construction having a communication function, an electronic board, an electronic signature receiving device, a projector, or various measuring instruments (such as a water meter, an electric meter, a gas meter, a wave meter, or the like). An electronic device disclosed herein can be one of the above-mentioned devices or any combination thereof. As well understood by those skilled in the art, the above-mentioned electronic devices are exemplary only and not to be considered as a limitation of this disclosure.

A system operating between an electronic device and an input interface can be MICROSOFT WINDOWS® computer operating system, APPLE MAC OS®, or an ANDROID OS®.

FIG. 1 is a block diagram illustrating an example configuration of electronic device 100 according to this disclosure. The electronic device 100 includes a communication module 110, input module 120, audio processing module 130, display module 140, storage module 150, processor 160, and vibration module 170. The electronic device 100 is functionally connected to an input interface 200 through a wired or wireless communication.

The communication module 110 is a module for supporting a mobile communication service of the electronic device 100. Such a communication module 110 forms a communication channel with a mobile communication system. For this, the communication module 110 includes a wireless frequency transmitter for up-converting and amplifying a transmitting signal and a receiver for low noise amplifying and down-converting a received signal.

The communication module 110 communicates with the input interface 200 through a wireless or wired communication. Here, the wireless communication includes at least one of a Wireless Fidelity (Wi-Fi), BLUETOOTH® (BT), Near Field Communication (NFC), a Global Positioning System (GPS), and cellular communication (such as Long Term Evolution (LTE), LTE-Advanced (LTE-A), Code Division Multiple Access (CDMA), Wideband CDMA (WCDMA), Universal Mobile Telecommunications System (UMTS), Wireless Broadband (WiBro), and Global System for Mobile (GSM)). The wired communication includes at least one of Universal Serial Bus (USB), High Definition Multimedia Interface (HDMI), Recommended Standard 232 (RS-232), and Plain Old Telephone Service (POTS).

The input module 120 includes a plurality of input keys and function keys for receiving numeral or character information and setting various functions. The function keys include direction keys, side keys, and shortcut keys configured to perform specific functions. Further, the input module 120 generates a key signal related to a user setting and a function control of the electronic device 100, and transmits it to the processor 160.

The audio processing module 130 includes a speaker (SPK) 132 for outputting an audio signal transmitted by the processor 160 and a microphone (MIC) 134 for collecting an audio signal according to activation of a specific application program in the electronic device 100. Such an audio processing module 130 outputs an audio signal received through the communication module 110 when the communication module 110 is activated.

The display module 140 displays various menus for the electronic device 100, information input by a user, or information provided for the user. The display module 140 provides various screens according to the use of electronic device, such as a waiting screen, menu screen, message preparation screen, and telephone screen. The display module 140 is formed with a Liquid Crystal Display (LCD), an Organic Light Emitted Diode (OLED), and an input means. The electronic device 100 provides various menu screens according to the support of display module 140.

The display module 140 is provided in a touch screen form by combining with a touch panel. For example, the touch screen is configured with an integral module combining a display panel and a touch panel. The touch panel recognizes a touch input with at least one of an electrostatic, pressure sensitive, infrared, or ultrasonic type. The touch panel further includes a controller. In the meantime, not only the direct touch but also proximity recognition is enabled in the electrostatic type. The touch panel further includes a tactile layer. In this case, the touch panel provides a tactile response for a user. The display module 140 detects a touch input event requesting for execution of a function in the electronic device 100. The display module 140 transmits information corresponding to the detected touch input event to the processor 160.

The storage module 150 stores an application program required for executing a function, application program for playing variously stored files, and a key map or menu map for the operation of display module 140 according to an embodiment of the present invention. Here, the key map and menu map are provided in various forms.

The key map includes a keyboard map, a 3×4 key map, a QWERTY key map, and a control key map for controlling an operation of currently activated application program. Further, the menu map is used as a control key map for controlling an operation of currently activated application program. Further, the menu map includes a menu map for controlling an operation of currently activated application program and a menu map having various menus provided by the electronic device 100. Such a storage module 150 includes a program area and a data area.

The program area includes an operating system (OS) for booting the electronic device 100 and operations of the above mentioned components and application programs for playing various files such as an application program for supporting a telephony function of the electronic device 100, web browser for connecting to an internet server, MP3 application program for playing a sound source, image output application program for displaying a photo, and video play application program.

The data area is an area where data generated according to the use of electronic device 100 are stored, and includes phonebook information, at least one icon according to a widget function, and various contents. Further, the data area stores a user input received through the display module 140 if installed in the display module 140. The storage module 150 according to an embodiment of the present invention stores information of a password, pattern image, and fingerprint recognition, with which a screen in a lock state is activated.

The storage module 150 according to an embodiment of the present invention stores data related to execution of a function corresponding to an input signal received from the input interface 200. The storage module 150 stores data corresponding to a pattern of input signal (such as a unit, button, and their combinations installed in the input interface 200) received from the input interface 200. For example, if the processor 160 receives an input signal generated by detecting an additional input unit from the input interface 200 and a movement signal generated by a directional movement of the input interface 200 (such as up, down, right, or left direction based on a surface contacting with the input interface 200). The storage module 150 stores a function to be transmitted to the processor 160 in a database. Here, the database includes each function corresponding to a combined input received from the input interface 200 (such as a combined input of units and buttons installed in the input interface 200). The processor 160 supports initialization of the electronic device 100 by controlling power supplies to each component, and controls each component if the initialization is completed.

The processor 160 identifies whether the electronic device 100 is connected to the input interface 200 in a wired method (such as by connecting input terminals of the electronic device 100 to connectors of the input interface 200 or connecting to the electronic device 100 through a cable or wire extended from the input interface 200) or in a wireless method. For example, when the processor 160 recognizes the input interface 200 in the wireless method, the processor 160 recognizes the input interface 200 through the communication module 110 by using BLUETOOTH®, infrared communication, or RF communication.

If a signal is received from the recognized input interface 200, the processor 160 controls to perform a function (such as displaying an image of an arrow mark in a screen, and click event or drag event of specific application) corresponding to a signal received through the display module 140. The processor 160 receives an input signal from the input interface 200 by detecting an input of an additional input unit formed at a side of the input interface 200. Here, the input signal received by the processor 160 includes a signal requesting for execution of a specific function and a signal requesting for switching to a specific mode (such as signal requesting for switching to a mode in order to perform a specific function), and pattern information (such as combinations of buttons installed in the input interface 200).

The processor 160 according to an embodiment of the present invention receives a movement signal by detecting a movement of the input interface 200 while an input of additional input unit is maintained through the input interface 200. Here, the movement signal includes information related to the movement of input interface 200 (such as up, down, right, and left directions, specific shape such as a diagonal line, ‘O’ shape, and ‘X’ shape). The movement of input interface 200 is detected through a control circuit and a sensor unit by installing an optical sensor or a mouse ball in the input interface 200.

The processor 160 according to an embodiment of the present invention receives a scroll signal by detecting an input of a scroll unit installed at a side of the input interface 200 while an input of an additional input unit is maintained through the input interface 200. Here, the scroll unit is a physical button corresponding to a function of moving a user interface displayed through the display module 140 in a specific direction (such as up, down, right, or left direction based on the user interface displayed in a screen through the display module 140. For example, the scroll unit is provided in a scroll wheel form.

The processor 160 according to an embodiment of the present invention controls the user interface based on the signal received from the input interface 200. The processor 160 controls to display a graphic user interface based on the received signal, controls to capture at least one area of a screen displayed through the display module 140, or controls an audio volume function. For example, the control of user interface includes a command event for executing a specific command and a control function of displaying a home screen.

The processor 160 controls to display at least one of a tray item including at least one image item displayed in an area of screen based on the signal received by the processor 160, application activated based on the received signal, and user interface for providing state information of the electronic device 100.

The processor 160 controls to display the user interface in a specific direction (such as left direction from the user interface displayed by the display module 140) same as the movement direction of the input interface 200 received from the input interface 200 (such as left direction from the input interface 200 when the screen and the input interface 200 face each other). For example, if the input interface 200 moves to the left side when the screen and the input interface 200 face each other, the processor 160 controls to display a tray item in the left direction based on the image item of the screen displayed through the display module 160.

Here, the tray item is an item group including at least one image item such as an application, shortcut icon, and thumbnail image. For example, the processor 160 controls to display a tray item including at least one image item at a side of the screen (such as left direction from the screen based on the input interface 200 when the screen displaying a user interface and the input interface 200 face each other).

Here, the activated application is an application currently being executed according to an input or an application not being executed after activation according to an input (such as a background application). For example, the processor 160 displays activated applications at a side of the screen (such as downward direction of the screen based on the input interface 200 or an area located at a lower side of image item displayed in the screen when the screen displaying a user interface and the input interface 200 are disposed facing each other).

Here, the user interface providing state information of the electronic device 100 includes battery state information of the electronic device 100, communication information, and memo information. For example, the processor 160 controls to switch a user interface currently being displayed based on a received signal to a user interface providing state information of the electronic device. The processor 160 according to an embodiment of the present invention receives a signal generated by detecting an input of selector for selecting an image item displayed in the screen of electronic device 100 or an input of popup window unit for displaying a predetermined popup window in the screen while an input of additional input unit is maintained through the input interface 200. The processor 160 adjusts a screen brightness of the electronic device 100 based on the received signal.

The processor 160 according to an embodiment of the present invention reduces the screen brightness displayed through the display module 140, if a signal generated by detecting an input of selector for selecting an image item displayed in the electronic device 100 is received while an input of additional input unit is maintained through the input interface 200. An image item is displayed in a screen through the display module 140 according to an embodiment of the present invention. If an input of selector for selecting a displayed image item is detected while the input interface 200 maintains an input of additional input unit, the electronic device 100 changes only the brightness of displayed image item to a predetermined brightness. For example, a plurality of image items (such as an application and thumbnail image) are displayed in a screen through the display module 140, and only the brightness of corresponding image item is reduced if inputs of the additional input unit and the selector are simultaneously detected through the input interface 200. Here, the predetermined brightness is changed by a user.

The processor 160 according to an embodiment of the present invention increases the brightness of screen displayed through the display module 140 if a signal generated by detecting an input of popup window unit for displaying a predetermined popup window is received while an input of additional input unit is maintained through the input interface 200. An image item is displayed in a screen through the display module 140 according to an embodiment of the present invention. If an input of popup window unit for displaying a predetermined popup window is detected while the input interface 200 maintains an input of additional input unit, the electronic device 100 changes only the brightness of displayed image item to a predetermined brightness. For example, a plurality of image items (such as an application and thumbnail image) are displayed in a screen through the display module 140, and only the brightness of image item is increased if inputs of the additional input unit and the popup window unit are simultaneously detected through the input interface 200. Here, the predetermined brightness is changed by a user.

The vibration module 170 generates various vibrations under the control of the processor 160, and includes at least one motor. The vibration module 170 is in a mute mode when receiving a telephone signal according to a user setting and is activated when an alarm time is reached.

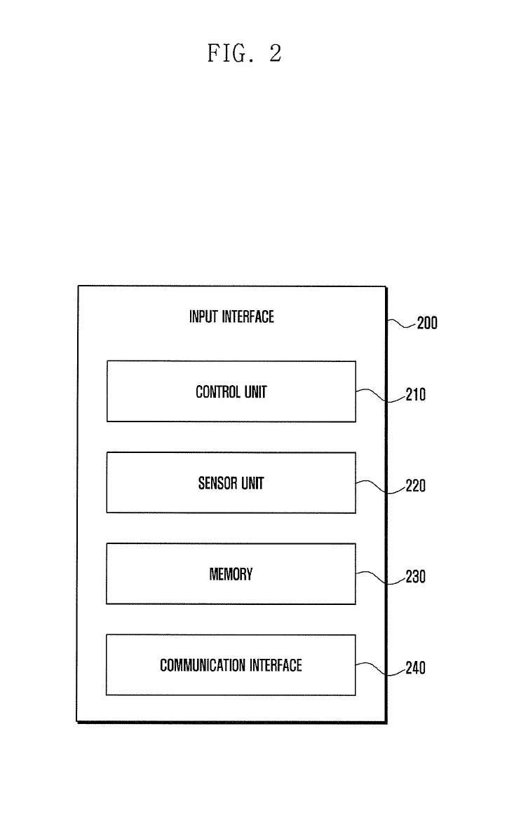

FIG. 2 is a block diagram illustrating an example configuration of input interface 200 according to this disclosure. The input interface 200 includes a control unit 210 and a sensor unit 220. The input interface 200 further includes a memory 230 or a communication interface 240 in addition to the control unit 210 and the sensor unit 220. For example, the input interface 200 includes only the control unit 210 and sensor unit 220 without installing the memory 230 and communication interface 240.

The input interface 200 is an input device functionally connected to the electronic device 100. For example, the input interface 200 is a computer input device such as a mouse and a mobile terminal.

The sensor unit 220 detects an input of additional input unit installed at a side of the input interface 200. Here, the input is a physical force applied from the outside. The sensor unit 220 transmits information of the input detection to the control unit 210. The control unit 210 controls to transmit the received information to the electronic device 100 in a wired or wireless method. In case of wireless transmission, the control unit 210 controls to transmit the received information to the electronic device 100 through the communication interface 240 by using BLUETOOTH®, infrared communication, RF communication, or the like. The additional input unit is installed between a recognizer for recognizing a movement of the input interface 200 and a selector for selecting a graphic user interface displayed through the display module 140 of electronic device 100.

The sensor unit 220 transmits a movement signal generated by detecting a movement of input interface 200 to the control unit 210 while an input of additional input unit is maintained through the input interface 200. The sensor unit 220 transmits a scroll signal generated by detecting an input of scroll unit installed at a side of the input interface 200 to the control unit 210. Here, the scroll signal is a signal for a function of moving an image item of screen in a specific direction. The control unit 210 transmits the received signal to the electronic device 100 by using a wired method (such as a cable and USB) or a wireless method (such as BLUETOOTH®, RF communication, infrared communication, or the like).

The memory 230 stores user interface control information corresponding to a movement signal generated by detecting a movement of input interface 200 while an input of additional input unit installed at a side of the input interface 200 is maintained. The memory 230 stores user interface control information corresponding to a scroll signal generated by detecting an input of scroll unit while an input of additional input unit is detected through the input interface 200.

The communication interface 240 transmits the user interface control information stored in the memory 230 to the electronic device. For example, the communication interface 240 transmits the user interface control information to the electronic device 100 when the input interface 200 and the electronic device 100 are functionally connected. If the input interface 200 and the electronic device 100 are functionally connected, a graphic user interface corresponding to the input interface 200 (such as an image item of an arrow mark) is displayed through the display module 140.

The communication interface 240 transmits the user interface control information to the electronic device 100 if the additional input unit installed at a side of the input interface 200 is pressed. The additional input unit is attachable or detachable. The additional input unit includes a memory 230. For example, the attachable/detachable additional input unit including a memory 230 is attached to a specific input interface 200.

The communication interface 240 transmits a signal requesting for switching a user interface of screen displayed through the display module 140 of electronic device 100 to an input interface mode, if an input of additional input unit is detected. Here, the request signal is a signal requesting for a control of user interface displayed through the display module 140 based on the information received from the input interface 200.

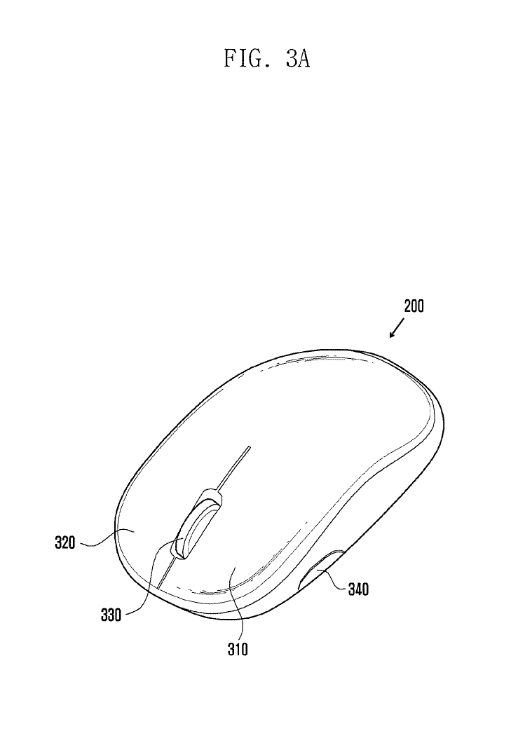

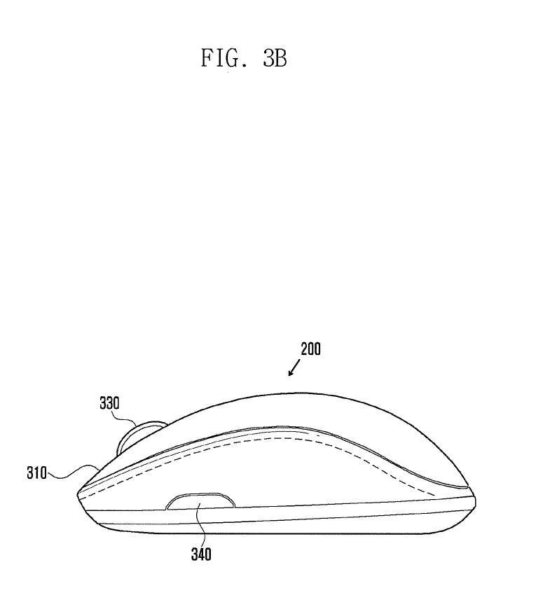

FIGS. 3A and 3B are schematic drawings illustrating an example configuration of input interface 200 according to this disclosure. Referring to FIGS. 3A and 3B, the input interface 200 includes a selector 310, popup window unit 320, scroll unit 330, and additional input unit 340. If a physical input of selector 310, popup window unit 320, scroll unit 330, or additional input unit 340 is detected from the outside, the input interface 200 transmits a signal corresponding to the detected input to the electronic device 100. Here, the scroll unit 330 has a scroll wheel. For example, if a text image item or a video image item cannot be fully displayed in a screen, a scroll image item performing a function of changing an image item displayed in the screen is additionally displayed in the screen. The processor 160 controls to perform a function of changing an image item displayed in a screen, if a signal is received by detecting an input of the scroll unit 330.

The input interface 200 according to an embodiment of the present invention includes a light emitting diode, optical engine, fluoroscope part, control part, mouse ball, and control circuit. The additional input unit 340 is installed at a side of the input interface 200. Here, the additional input unit 340 is installed in a form of protruding from a side of the input interface 200. For example, the additional input unit 340 is installed, fused, deposited, or attached in a lower left area of the input interface 200 (such as an area between the selector 310 and a side surface of the input interface 200 disposed on a plane and contacting the input interface 200 when input interface 200 moves on the plane). The additional input unit 340 is formed with a material of gum or plastic. The input interface 200 transmits an input signal generated by physically pressing the additional input unit 340 to the electronic device 100. The additional input unit 340 is installed in a form of protruding from a plane of the input interface 200.

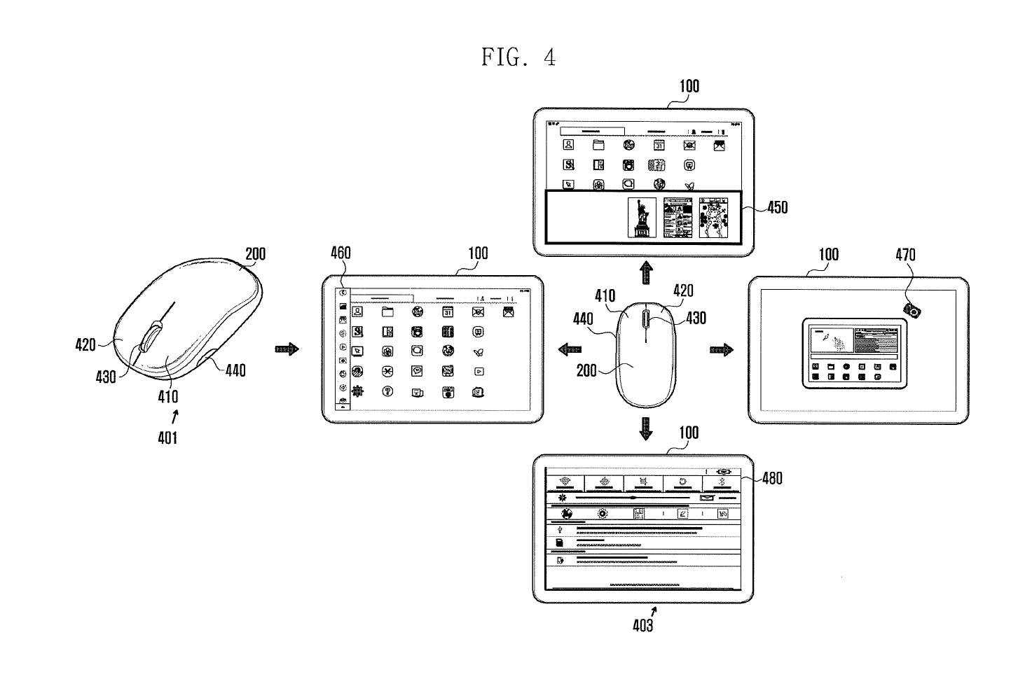

FIG. 4 is a schematic drawing illustrating an example method of performing a function corresponding to an input of input interface 200 in an electronic device 100 according to this disclosure. Referring to reference number 401, the electronic device 100 receives a signal generated by detecting an input of a selector 410, popup window unit 420, scroll unit 430, or additional input unit 440 of the input interface 200. The electronic device 100 controls to perform a function corresponding to a signal received from the input interface 200.

Referring to reference number 403, the electronic device 100 receives a movement signal generated by moving the input interface 200 upwards, downward, rightwards, or leftwards based on a surface contacting the input interface 200 while an input of the additional input unit 440 of the input interface 200 is maintained. The processor 160 controls to perform a function corresponding to a signal received through the display module 140.

For example, if the electronic device 100 is a tablet Personal Computer (PC) and the input interface 200 moves to the left side based on a surface facing the input interface 200 while an of the input device 400 pressing the additional input unit 440 is maintained, the tablet PC controls to display a tray item 460 at the right side of screen including a plurality of applications (such as in a movement direction of input interface 200 in a screen displaying an image item).

As another example, if the electronic device 100 is a tablet PC and the input interface 200 moves to the upper side based on a surface facing the input interface 200 while an input of the input device 400 pressing the additional input unit 440 is maintained, the tablet PC controls to display a currently activated application 450 at the upper side of the screen. As another example, if the electronic device 100 is a tablet PC and a signal of moving the input interface 200 to the lower side is received based on a surface facing the input interface 200 while an input of the input device 400 pressing the additional input unit 440 is maintained, the tablet PC controls to switch the currently displaying screen to a user interface 480 providing state information of the electronic device 100.

As another example, if the electronic device 100 is a tablet PC and a signal of moving the input interface 200 to the right side is received based on a surface facing the input interface 200 while an input of the input device 400 pressing the additional input unit 440 is maintained, the tablet PC controls to display a user interface 470 for providing information of a capture function.

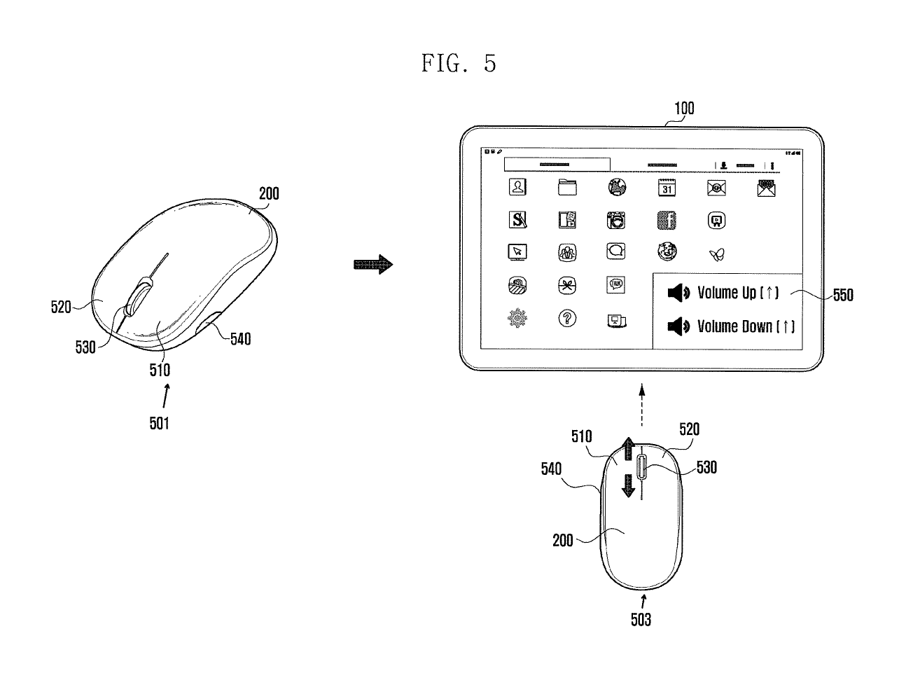

FIG. 5 is a schematic drawing illustrating an example method of performing a function corresponding to an input of input interface 200 in an electronic device 100 according to this disclosure. Referring to reference number 501, the electronic device 100 receives a signal generated by detecting an input of a selector 510, popup window unit 520, scroll unit 530, or additional input unit 540 of the input interface 200. The electronic device 100 controls to perform a function corresponding to the signal received from the input interface 200.

Referring to reference number 503, the electronic device 100 receives a signal generated by detecting an input of the scroll unit 530 (such as a scroll input of scroll wheel or mouse ball installed in the input interface 200) while an input of additional input unit 540 in the input interface 200 is maintained.

The electronic device 100 according to an embodiment of the present invention controls an audio output function based on the received signal. For example, the electronic device 100 controls to execute a function of increasing an audio volume if a scroll up signal is received from the scroll unit 530. The electronic device 100 displays a user interface 550 corresponding to the execution of function. Here, the scroll up signal is a signal generated by pressing the scroll unit 530 installed at a side of the input interface 200 in a specific direction (such as an upward direction based on the selector 510 and the popup window unit 520). The electronic device 100 controls to execute a function of decreasing the audio volume if a scroll down signal is received from the scroll unit 530. Here, the scroll down signal is a signal generated by pressing the scroll unit 530 installed at a side of the input interface 200 in a specific direction (such as a downward direction based on the selector 510 and the popup window unit 520).

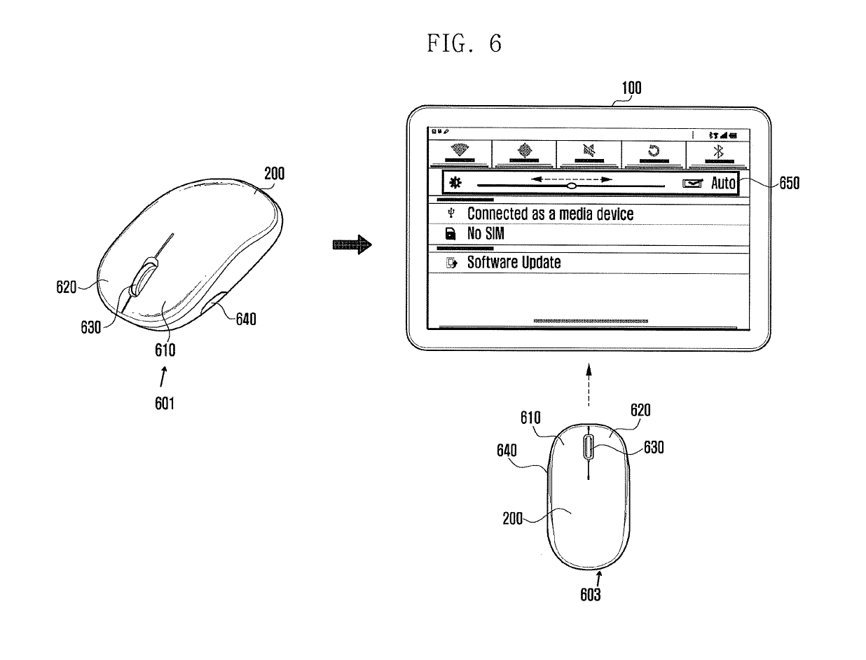

FIG. 6 is a schematic drawing illustrating an example method of performing a function corresponding to an input of input interface 200 in an electronic device 100 according to this disclosure. Referring to reference number 601, the electronic device 100 receives a signal generated by detecting an input of a selector 610, popup window unit 620, scroll unit 630, or additional input unit 640 of the input interface 200. The electronic device 100 controls to execute a function corresponding to the signal received from the input interface 200.

Referring to reference number 603, the electronic device 100 receives a signal generated by detecting an input of the selector 610 or the popup window unit 620 while an input of the additional input unit 640 in the input interface 200 is maintained. The electronic device 100 according to an embodiment of the present invention adjusts the brightness of screen displayed through the display module 140 based on the received signal. The electronic device 100 according to an embodiment of the present invention displays a graphic user interface 650 for adjusting the brightness of screen based on the received signal. For example, the brightness of screen displayed through the display module 140 is decreased, if an input of the input interface 200 selector 610 is detected while an input of the additional input unit 640 is maintained. The brightness control of the electronic device 100 can include a resolution adjustment of screen. As another example, the brightness of screen displayed through the display module 140 is increased, if an input of the popup window unit 620 is detected while an input of the additional input unit 640 in the input interface 200 is maintained.

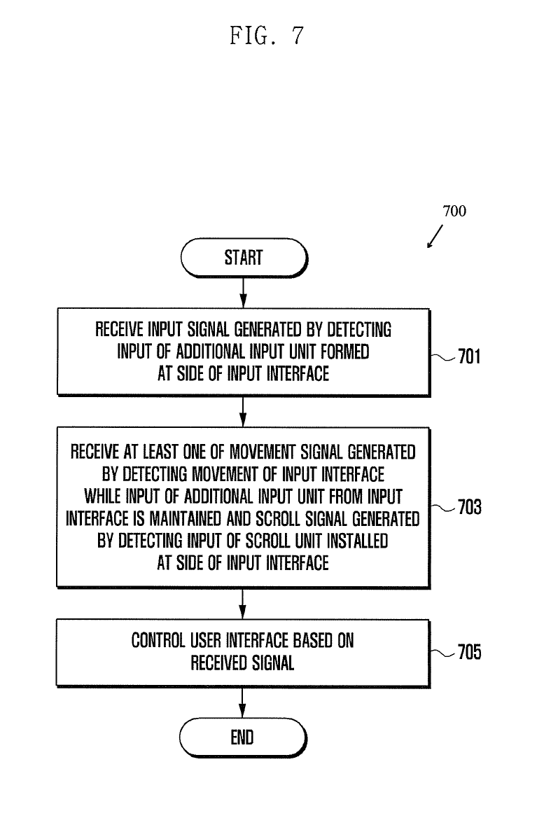

FIG. 7 is a flowchart illustrating an example method 700 of performing a function corresponding to an input of input interface 200 in an electronic device 100 according to this disclosure. The processor 160 receives a signal generated by detecting an input of additional input unit installed at a side of the input interface 200 at operation 701. Here, the processor 160 receives an input signal from the input interface 200 in a wired or wireless method. The processor 160 receives at least one of a movement signal generated by detecting a movement of the input interface 200 and a scroll signal generated by detecting an input of scroll unit installed at a side of the input interface 200 while an input of the additional input unit is maintained at operation 703.

The processor 160 controls a user interface based on the received signal at operation 705. The processor 160 controls to display a graphic user interface based on the received signal, control to capture at least one area of screen, or control an audio volume function. The processor 160 controls to display a tray item including at least one image item in an area of screen based on the received signal. The processor 160 identifies an activated application based on the received signal, and controls to display the identified application in an area of screen. The processor 160 controls to display a user interface providing state information of the electronic device 100 based on the received signal.

The processor 160 receives a signal generated by detecting an input of selector for selecting an image item displayed in the electronic device 100 or an input of popup window unit for displaying a predetermined popup window while an input of additional input unit is maintained. The processor 160 adjusts a screen brightness of the electronic device based on the received signal.

An electronic device displays a user interface if an input signal for performing a predetermined function from an input interface. Accordingly, user convenience and accessibility is improved in displaying a user interface. An electronic device controls to execute a predetermined function corresponding to an input signal if the input signal is received from the input interface. Accordingly, a function desired by a user is executed more quickly and conveniently.

Although exemplary embodiments of the invention have been described in detail above, it should be understood that many variations and modifications of the basic inventive concept herein described, which may be apparent to those skilled in the art, will still fall within the spirit and scope of the exemplary embodiments of the invention as defined in the appended claims.

What is claimed is:

1. An electronic device comprising:
a display module;
an input interface configured to:
be functionally connected to the electronic,
transmit an input detection signal to the electronic device by detecting an input of additional input unit formed at a side, and
transmit to the electronic device at least one of a movement signal generated by detecting a movement while an input of the additional input unit is maintained and a scroll signal generated by detecting an input of a scroll unit installed at a side; and
a processor configured to:
receive an input detection signal from the input interface,
receive at least one of the movement signal and the scroll signal while the input of the additional input unit is maintained, and
control a user interface based on the received signal.

2. The electronic device of claim 1, wherein the processor is configured to control to display a graphic user interface through the display module, control to capture at least one area of screen, or control an audio volume function based on the received signal.

3. The electronic device of claim 2, wherein the processor is configured to control to display at least one of a tray item including at least one image item, and a graphic user interface providing an activated application and state information of the electronic device in the area of screen based on the received signal.

4. The electronic device of claim 1, wherein the input interface is configured to transmit to the electronic device a signal generated by detecting an input of a selector for selecting an image item of screen displayed through the display module or a signal generated by detecting an input of a popup window unit for displaying a predetermined popup window in the screen while an input of the additional input unit is maintained, and wherein the processor is configured to receive a signal generated by detecting an input of the selector or an input of the popup window unit and adjust a screen brightness of the electronic device based on the received signal while an input of the additional input unit is maintained.

5. A method to control a user interface in an electronic device, the method comprising:
receiving an input detection signal generated by detecting an input of an additional input unit formed at a side of the input interface by a processor;
receiving at least one of a movement signal generated by detecting a movement of the input interface and a scroll signal generated by detecting an input of a scroll unit installed at a side of the input interface while an input of the additional input unit is received from the input interface by the processor; and
controlling a user interface based on the received signal by the processor.

6. The method of claim 5, wherein controlling a user interface based on the received signal by the processor comprises:
controlling to display a graphic user interface based on the received signal by the processor;
controlling to capture at least one area of screen based on the received signal by the processor; and
controlling an audio volume function by the processor.

7. The method of claim 6, wherein controlling to display a graphic user interface based on the received signal by the processor comprises at least one of:
controlling to display a tray item including at least one image item in at least one area of screen based on the received signal by the processor;
identifying an activated application and controlling to display the identified application in an area of screen based on the received signal by the processor; and
controlling a user interface providing state information of the electronic device based on the received signal by the processor.

8. The method of claim 5, further comprising:
receiving a signal generated by detecting an input of a selector for selecting an image item of screen displayed through the display module or a signal generated by detecting an input of a popup window unit for displaying a predetermined popup window in the screen while an input of the additional input unit is maintained by the processor; and
adjusting a screen brightness of the electronic device based on the received signal by the processor.

9. An input interface comprising:
a memory configured to store user interface control information corresponding to a movement signal generated by moving the input device while an input of an additional input unit installed at a side of the input interface is detected, and to store user interface control information corresponding to a scroll signal generated by detecting an input of a scroll unit while an input of the additional input unit is detected; and
an input interface configured to include a communication interface for transmitting the stored user interface control information to an electronic device.

10. The input interface of claim 9, wherein the communication interface is configured to transmit the user interface control information to the electronic device when functionally connected to the electronic device.

11. The input interface of claim 9, wherein the communication interface is configured to transmit the user interface control information to the electronic device when an additional input unit installed at a side of the input interface is pressed.

12. The input interface of claim 9, wherein the additional input unit is installed in an area between a recognizer for identifying a movement of the input interface and a selector for selecting a graphic user interface displayed through a screen of the electronic device.

13. The input interface of claim 9, wherein the additional input unit is attachable and detachable.

14. The input interface of claim 13, wherein the additional input unit includes a memory.

15. The input interface of claim 9, wherein the communication interface is configured to transmit a request signal for switching a user interface of a screen displayed through a display module of the electronic device to an input interface mode if an input of the additional input unit is detected.

16. The electronic device of claim 1, wherein the electronic device is at least one of a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device.

17. The method of claim 5, wherein the electronic device is at least one of a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device.

18. The input interface of claim 9, wherein the input interface is a component of an electronic device, and wherein the electronic device is at least one of a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device.

19. The input interface of claim 9, wherein the input interface is communicatively coupled to a display module.

20. The input interface of claim 9, wherein the input interface is communicatively coupled to a processor configured to a processor configured to:
receive an input detection signal from the input interface,
receive at least one of the movement signal and the scroll signal while the input of the additional input unit is maintained, and
control a user interface based on the received signal.
